(19) United States
(12) Patent Application Publication
(10) Pub. No.: US 2016/0116919 A1
(43) Pub. Date: Apr. 28, 2016

(54) PNEUMATIC DETECTION OF MODULAR TOOLING CONNECTION

(71) Applicant: Norgren Automation Solutions, LLC, Saline, MI (US)

(72) Inventors: Michael Thomas Charlton, Clinton, MI (US); Prabath Wijesekara Arachchige, Ypsilanti, MI (US)

(21) Appl. No.: 14/923,849

(22) Filed: Oct. 27, 2015

Related U.S. Application Data
(60) Provisional application No. 62/068,876, filed on Oct. 27, 2014.

(51) Int. Cl. G05D 7/06

(52) U.S. Cl. CPC G05D 7/0635

(57) ABSTRACT

An apparatus includes a mechanical coupler portion and a pneumatic detection valve that is connected to the mechanical coupler portion, connectable to a source of pressurized air, and is moveable between a first position and a second position, wherein the pneumatic detection valve prevents communication of the pressurized air with atmosphere in the first position, prevents communication of the pressurized air with atmosphere in the second position, and leaks the pressurized air to atmosphere when in an intermediate position between the first position and the second position.

### CROSS-REFERENCE TO RELATED APPLICATIONS

This application claims the benefit of U.S. Provisional Application No. 62/068,876 filed on Oct. 27, 2014.

### BACKGROUND

In the manufacturing field, modular tooling systems are utilized to allow the tools being used on a certain machine or production line to be changed quickly, while positioning the tools with high levels of accuracy and precision. Tool changes allow a single machine or production line to be adapted to different uses, such as transitioning from production of a first product to production of a second product.

Modular tooling systems often include couplers that are utilized to mechanically connect and disconnect tools from a base. For example, the base can be a moving structure such as a robotic arm. One or more couplers on the base are connectable to and disconnectable from multiple tooling assemblies. The couplers often include locking mechanisms that prevent accidental separation of the modular tooling assembly from the base.

Some tooling assemblies include tools that are powered, such as by electricity or a pressurized gas such as air. As one example, a tooling assembly could include a pneumatic clamp that is powered by a source of pressurized air, with the clamp being actuated by an electrically operated valve that is part of the tooling assembly and is actuated by an electronic control signal that originates from a central controller that is not part of the tooling assembly. As another example, a vacuum cup gripper can be operated by connection to a negative pressure source. With respect to these types of tooling assemblies, the connection of the tooling assembly to the base includes the mechanical connection provided by the couplers or similar devices, as well as electrical and pneumatic connections. To allow for rapid tool change systems, known couplers include mechanical, pneumatic, and electrical connections that can be connected by a single operation, such as by sliding a first coupler part into a second coupler part until the two are firmly connected and a mechanical locking mechanism engages. The mechanical locking mechanism prevents disconnection of the first coupler part with respect to the second coupler part while it remains engaged. Disconnection of the first coupler part from the second coupler part is performed similarly, usually by releasing the mechanical locking mechanism (such as by a lever) and moving the first coupler part away from the second coupler part.

### SUMMARY

One aspect of the disclosed embodiments is an apparatus includes a mechanical coupler portion and a pneumatic detection valve that is connected to the mechanical coupler portion, connectable to a source of pressurized air, and is moveable between a first position and a second position, wherein the pneumatic detection valve prevents communication of the pressurized air with atmosphere in the first position, prevents communication of the pressurized air with atmosphere in the second position, and leaks the pressurized air to atmosphere when in an intermediate position between the first position and the second position.

Another aspect of the disclosed embodiments is an apparatus that includes a base structure having a first mechanical coupler portion and a first pneumatic coupler portion, The first pneumatic coupler portion is connected to the first mechanical coupler portion, is connectable to a source of pressurized air, includes a pneumatic detection valve that is moveable between a first position and a second position, wherein the pneumatic detection valve prevents communication of the pressurized air with atmosphere in the first position, prevents communication of the pressurized air with atmosphere in the second position, and leaks the pressurized air to atmosphere when in an intermediate position between the first position and the second position, and includes a pneumatic supply valve that is moveable between an open position and a closed position. The apparatus also includes a modular tool having a second mechanical coupler that is moveable with respect to the first mechanical coupler portion between a disconnected position and a connected position and a second pneumatic coupler portion. The second mechanical coupler portion is connectable to the first pneumatic coupler portion, the second pneumatic coupler portion having a connecting part that is operable to receive the pressurized air from the pneumatic supply valve.

Another aspect of the disclosed embodiments is an apparatus that includes a base structure having a first mechanical coupler portion and a first pneumatic coupler portion. The first pneumatic coupler portion is connected to the first mechanical coupler portion and is connectable to a source of pressurized air. The first pneumatic coupler includes a pneumatic detection valve that is moveable between a first position and a second position, wherein the pneumatic detection valve prevents communication of the pressurized air with atmosphere in the first position, prevents communication of the pressurized air with atmosphere in the second position, and leaks the pressurized air to atmosphere when in an intermediate position between the first position and the second position. The pneumatic detection valve includes a contact shaft that is disposed at least partially within a valve bore that is formed in a valve body of the first pneumatic coupler portion. A portion of the contact shaft extends out of an open end of the valve bore when the pneumatic detection valve is in the first position, the contact shaft is disposed entirely within the valve bore when the pneumatic detection valve is in the second position, and the first pneumatic coupler includes a pneumatic supply valve that is moveable between an open position and a closed position. The pneumatic supply valve is disposed in the closed position when the pneumatic detection valve is disposed in the first position and the pneumatic supply valve is disposed in the open position when the pneumatic detection valve is disposed in the second position. The modular tool includes a second mechanical coupler that is moveable with respect to the first mechanical coupler portion between a disconnected position and a connected position and a second pneumatic coupler portion. The second pneumatic coupler portion is connectable to the first pneumatic coupler portion, the second pneumatic coupler portion having a connecting part that is operable to receive the pressurized air from the pneumatic supply valve. Engagement of at least a portion of the modular tool with the pneumatic detection valve is operable to move the pneumatic detection valve between the first position and the second position. The apparatus also includes a sensor that is operable to sense at least one of the pressure or the flow rate of the pressurized air and a controller that receives an output signal from the controller. The controller detects a leak to atmosphere by the pneumatic detection valve based on the output signal, wherein the controller outputs an interlock signal for preventing operation of a machine in response to detecting the leak to atmosphere.

### BRIEF DESCRIPTION OF THE DRAWINGS

The various other uses of the apparatus will become more apparent by referring to the following detailed description and drawings in which:

FIG. 1 is a perspective view of a modular tooling assembly that includes a modular tool and a base portion according to a first example;

FIG. 2 is a cross-section view of a first pneumatic coupler portion that includes a pneumatic valve with the pneumatic valve in a disconnected position;

FIG. 3 is a partial cross-section view of the modular tooling assembly with the pneumatic valve in an intermediate position;

FIG. 4 is a partial cross-section view of the modular tooling assembly with the pneumatic valve in a connected position;

FIG. 5 is a block diagram showing a system that includes the pneumatic valve of FIG. 2 and is configured to detect whether the modular tool is properly connected to the base structure;

FIG. 6 is an exploded perspective view of a modular tooling assembly that includes a modular tool and a base portion according to a second example;

FIG. 7 is a cross-section view showing a pneumatic supply valve in a closed position and a pneumatic detection valve in a fully extended position;

FIG. 8 is a cross-section view showing the pneumatic supply valve in the closed position and the pneumatic detection valve in an intermediate position; and

FIG. 9 is a cross-section view showing the pneumatic supply valve in an open position and the pneumatic detection valve in a fully retracted position.

### DETAILED DESCRIPTION

The disclosure herein is directed to pneumatic couplers that are used with pressurized air lines. As used herein, “pressurized” refers to all pressures other than atmospheric pressure, including compressed air and vacuum.

One pneumatic coupler disclosed herein include a pneumatic valve that includes a plurality of ports such as a first group of one or more ports and a second group of one or more ports that define an air flow path through the valve when the coupler is connected, and block air flow when the coupler is not connected. In an intermediate position, at least one of the ports is in communication with a supply of pressurized air and at least another of the ports is exposed to ambient pressure, such that at least some of the pressurized air is exposed to atmosphere. Thus, the compressed air or vacuum pressure is vented to atmosphere. In the case of vacuum pressure, this causes atmospheric air to be introduced into the coupler. In the case of vacuum, atmospheric air is introduced into the vacuum line.

Another pneumatic coupler disclosed herein include a pneumatic valve that includes a plurality of ports such as a first group of one or more ports and a second group of one or more ports that define an air flow path through the valve when the coupler is connected, and block air flow when the coupler is not connected. In an intermediate position, at least one of the ports is in communication with a supply of pressurized air and at least another of the ports is exposed to ambient pressure, such that at least some of the pressurized air is exposed to atmosphere. Thus, the compressed air or vacuum pressure is vented to atmosphere. In the case of vacuum pressure, this causes atmospheric air to be introduced into the coupler. In the case of vacuum, atmospheric air is introduced into the vacuum line.

The pneumatic couplers and valves described herein can be utilized to implement systems that detect improper connection of a modular tooling assembly, by detecting a leak to ambient pressure using a leak detector, as will be explained herein. In some applications, venting the pressurized air in the intermedia position can have the additional benefit of reducing the amount of force that must be applied to the coupler in order to connect it, by reducing the backpressure caused by the pressurized air as the valve is moved to the connected position.

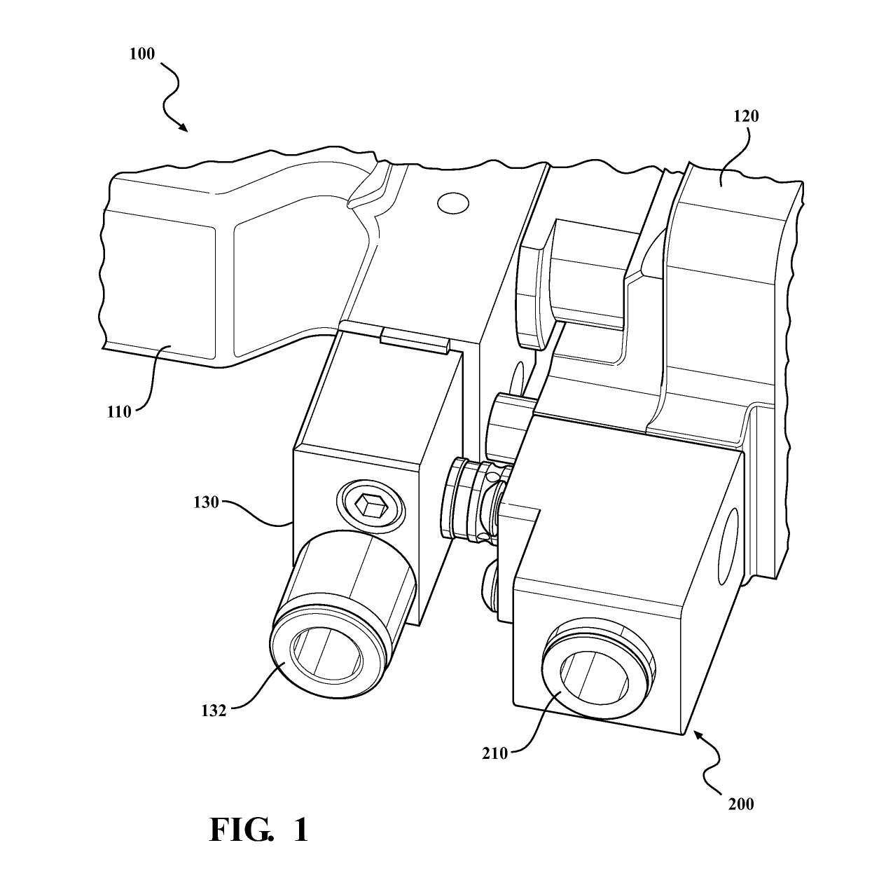

As shown in FIG. 1 a modular tooling assembly 100 that includes a modular tool 110 and a base structure 120. The modular tool 110 and the base structure 120 each include respective mechanical coupler portions (not shown) that are connectable and disconnectable to allow the modular tool 110 to be secured to and removed from the base structure 120 by movement of the modular tool 110 between a disconnected position and a connected position with respect to the base structure 120.

The base structure 120 includes a first pneumatic coupler portion 200 that includes a pneumatic valve. The first pneumatic coupler portion 200 has an inlet 210 that is connectable to a source of pressurized air, such as by pneumatic tubing (not shown) or other suitable structures.

The modular tool 110 includes a second pneumatic coupler portion 130 that has an outlet 132. The outlet 132 is connected to one or more pneumatic tools (not shown) that are supported by the modular tool 110, such as by pneumatic tubing (not shown) or other suitable structures.

The first pneumatic coupler portion 200 and the second pneumatic coupler portion 130 can be connected by moving the second pneumatic coupler portion 130 toward the first pneumatic coupler portion 200 and can be disconnected by moving the second pneumatic coupler portion 130 away from the first pneumatic coupler portion 200. The first pneumatic coupler portion 200 and the second pneumatic coupler portion 130 are connected to the modular tool 110 and the base structure 120 such that the motion that occurs during connection and disconnection of the respective mechanical coupler portions of the modular tool 110 and the base structure 120 causes connection and disconnection of the first pneumatic coupler portion 200 and the second pneumatic coupler portion 130.

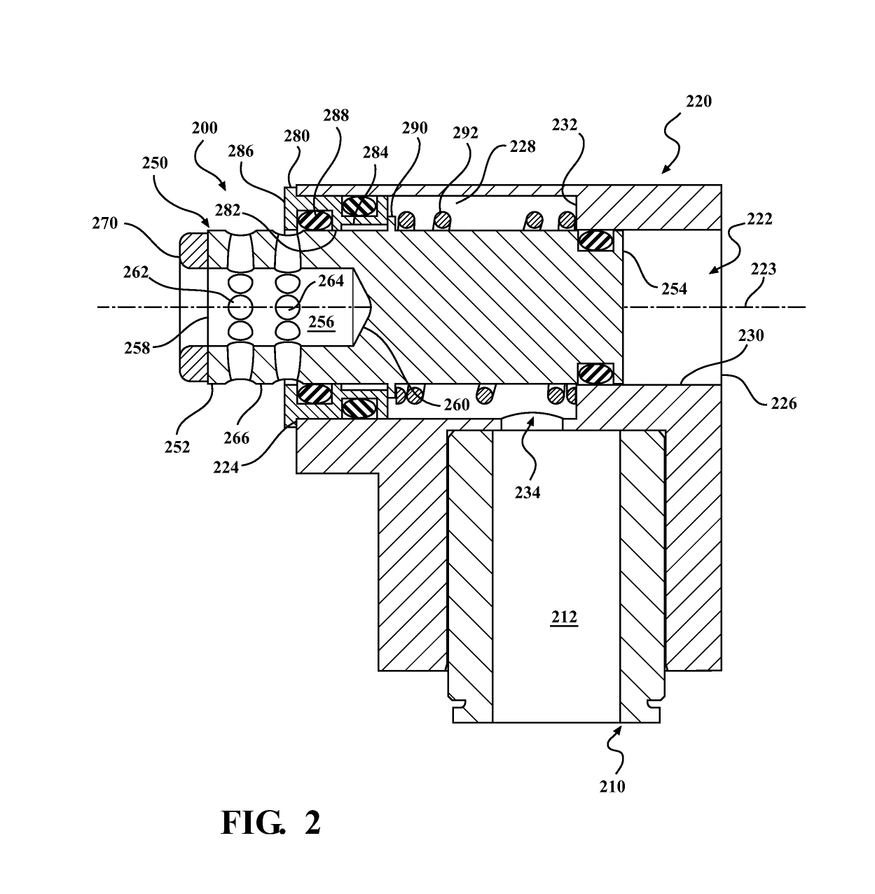

As shown in FIG. 2, the first pneumatic coupler portion 200 includes the inlet 210, a valve body 220, a valve member 250, and a valve seat member 280.

The inlet 210 allows pressurized air to enter the first pneumatic coupler portion 200, and is connectable to a source of pressurized air for supplying the pressurized air to the valve body 220 and the valve member 250. The inlet 210 is connected to the valve body 220. In one implementation the inlet 210 is formed separately from the valve body 220 and subsequently connected to the valve body 220 by conventional structures and methods. In another implementation the inlet 210 is formed integrally with the valve body 220. The inlet 210 defines an internal space such as an inlet bore 212 in which the pressurized air is received.

The valve body 220 includes a valve bore 222 that extends through the valve body 220 along a valve axis 223. The valve bore 222 is in fluid communication with the inlet 210. In the illustrated example, the valve bore 222 receives pressurized air from the inlet bore 212 via a passage 234 that is formed inside the valve body 220 and connects the inlet bore 212 to the valve bore 222.

The valve bore 222 extends from a first open end 224 to a second open end 226. The valve bore 222 has a stepped inner diameter defined by a first diameter throughout a first portion 228 of the valve bore 222 and a second diameter throughout a second portion 230 of the valve bore 222. The first diameter is greater than the second diameter. The first diameter is larger than an outside diameter of the valve member 250. The second diameter is complementary to the outside diameter of the valve member 250, such that the valve member 250 is slightly smaller than the second portion 230 of the valve bore 222 and is thus able to slide smoothly within it. The first portion 228 of the valve bore 222 extends from the first open end 224 to an internal shoulder 232 of the valve bore 222. The internal shoulder 232 narrows the diameter of the valve bore 222 from the first diameter of the first portion 228 to the second diameter of the second portion 230, which extends from the internal shoulder 232 to the second open end 226 of the valve bore 222.

The valve member 250 is disposed at least partially within the valve bore 222 of the valve body 220 and moves along the valve axis 223 to block or permit flow of the pressurized air, as will be explained further herein. The valve member 250 extends from a first end 252 to a second end 254. The valve member 250 can be a substantially cylindrical structure that extends along the valve axis 223 of the valve body 220. The valve member 250 is movable with respect to the valve body 220, with its motion being restricted to the axial direction (i.e. along the valve axis 223) by virtue of engagement of the valve member 250 with the second portion 230 of the valve bore 222 and with the valve seat member 280.

An internal passageway 256 is formed in the valve member 250 for conducting the pressurized air from the valve bore 222 to the second pneumatic coupler portion 130 when the first pneumatic coupler portion 200 is connected to the second pneumatic coupler portion 130. The internal passageway 256 extends from an open end 258 at the first open end 224 of the valve bore 222 to a closed end 260 inside the valve member 250.

Fluid communication of the internal passageway 256 of the valve member 250 is established or blocked dependent upon the position of the valve member 250 with respect to the valve seat member 280. Fluid communication between the valve bore 222 of the valve body 220 and the internal passageway 256 of the valve member 250 occurs via a first group of ports 262 and a second group of ports 264.

Each of the first group of ports 262 and the second group of ports 264 includes one or more ports that extend from the internal passageway 256 to an external surface 266 of the valve member 250. For example, the first group of ports 262 and the second group of ports 264 can each include a plurality of ports that are positioned in an array around the periphery of the valve member 250 at a common distance from the open end 258 of the internal passageway 256 and extend radially through the valve member 250 transverse to the valve axis 223.

The first group of ports 262 is located at a first axial distance (i.e. measured along the valve axis 223) from the open end 258 of the valve member 250. The second group of ports 264 is located at a second axial distance (i.e. measure along the valve axis 223) from the open end 258 of the valve member 250. The second axial distance is greater than the first axial distance. The relative axial spacing of the first group of ports 262 with respect to the second group of ports 264 allows the valve member to be axially positioned with respect to the valve seat member 280 such that the internal passageway 256 of the valve member is in communication with the valve bore 222 via the second group of ports 264 while the first group of ports 262 is exposed to atmosphere.

At the first open end 224 of the valve member 250, an annular seal 270 is fixed to the end of the valve member 250 and surrounds the open end 258 of the internal passageway 256. The annular seal 270 is engages with the second pneumatic coupler portion 130 when the first pneumatic coupler portion 200 is connected to the second pneumatic coupler portion 130, as will be explained herein.

The valve seat member 280 is connected to the valve body 220, and is located at the first open end 224 of the valve bore 222. The valve seat member 280 is an annular member having its outer periphery engaged with the valve body 220. An inner periphery of the valve seat member 280 includes a first portion 282 and a second portion 284. The first portion 282 extends inward from a front face 286 of the valve seat member 280. The first portion 282 has a diameter that is complementary to the outside diameter of the valve member 250, and defines a valve seat that engages the valve member 250 to block air flow past the valve seat member 280. In the illustrated example, the valve seat is defined by an annular sealing ring 288 (e.g. an O-ring) set in a groove on the first portion 282 of the inner periphery of the valve seat member 280. The second portion 284 has a diameter that is larger than that of the valve member 250 and thus defines an air space that allows for fluid communication between the valve bore 222 and the internal passageway 256 via either of the first group of ports 262 or the second group of ports 264, respectively, when they are positioned adjacent to the second portion 284. As a result, the first group of ports 262 and the second group of ports 264 will each be in fluid communication with the valve bore 222 when positioned inward of the valve seat defined by the first portion 282 of the valve seat member 280 and will not be in fluid communication with the valve bore 222 when positioned at or outward of the valve seat defined by the first portion 282 of the valve seat member 280.

In order to retain the valve member 250 in the valve bore 222, a stop ring 290 is formed around the periphery of the valve member 250. The stop ring 290 engages the valve seat member 280, and this engagement retains the valve member 250 in the valve bore 222. The stop ring 290 can have axially extending gaps, notches, apertures, or other interruptions formed in it to allow air to flow into the space between the second portion 284 of the valve seat member 280 and the valve member 250 when the stop ring 290 is engaged with the valve seat member 280. The valve member 250 is urged toward engagement with the valve seat member 280 (which corresponds to a closed position for the valve) by a spring force that is applied to the stop ring 290 of the valve member 250 by a compression spring 292. The compression spring 292 has a first end that is engaged with the stop ring 290 and a second end that is engaged with the internal shoulder 232 of the valve body 220.

The valve member 250 is movable with respect to the valve body 220 to define a closed position, an intermediate position (also referred to as a “vent position”), and an open position. In the closed position (FIG. 2), air flow is blocked by the valve member 250. In particular, both the first group of one or more ports 262 and the second group of one or more ports 264 are positioned outward of the valve seat defined by the annular sealing ring 288, thereby preventing flow of air from the valve bore 222 into the internal passageway 256 of the valve member 250.

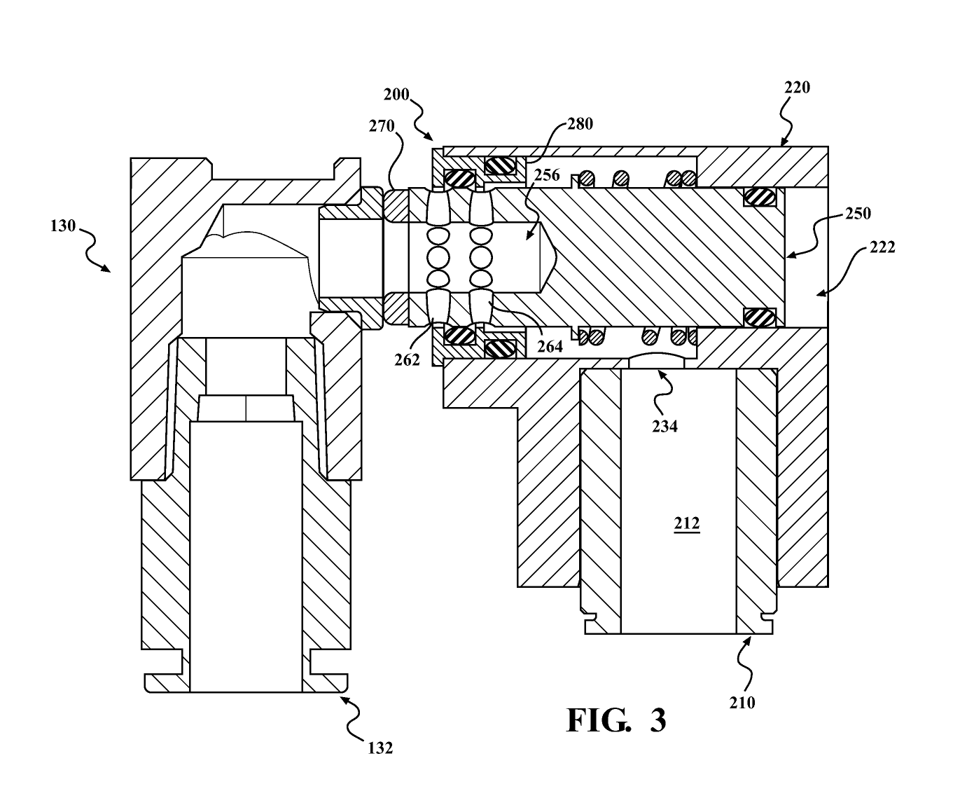

In FIG. 3, the annular seal 270 of the valve member 250 has been engaged by a connecting part 134 of the second pneumatic coupler portion 130 and this engagement has move the valve member 250 to the vent position. Any air that passes out of the open end 258 of the valve member 250 will enter the interior of the second pneumatic coupler portion 130 by virtue of the seal established at the open end 258 with the connecting part 134 by the annular seal 270. In the vent position, the first group of one or more ports 262 is located outward of the valve seat defined by the annular sealing ring 288 and thus exposed to atmosphere while the second group of one or more ports 264 is disposed inward of the valve seat defined by the annular sealing ring 288 and exposed to the pressurized air in the valve bore 222. Air that flows into the internal passageway 256 of the valve member 250 via the second group of one or more ports 264 while the first group of one or more ports 262 is exposed to atmosphere will be at least partially exposed to atmosphere through the first group of one or more ports 262.

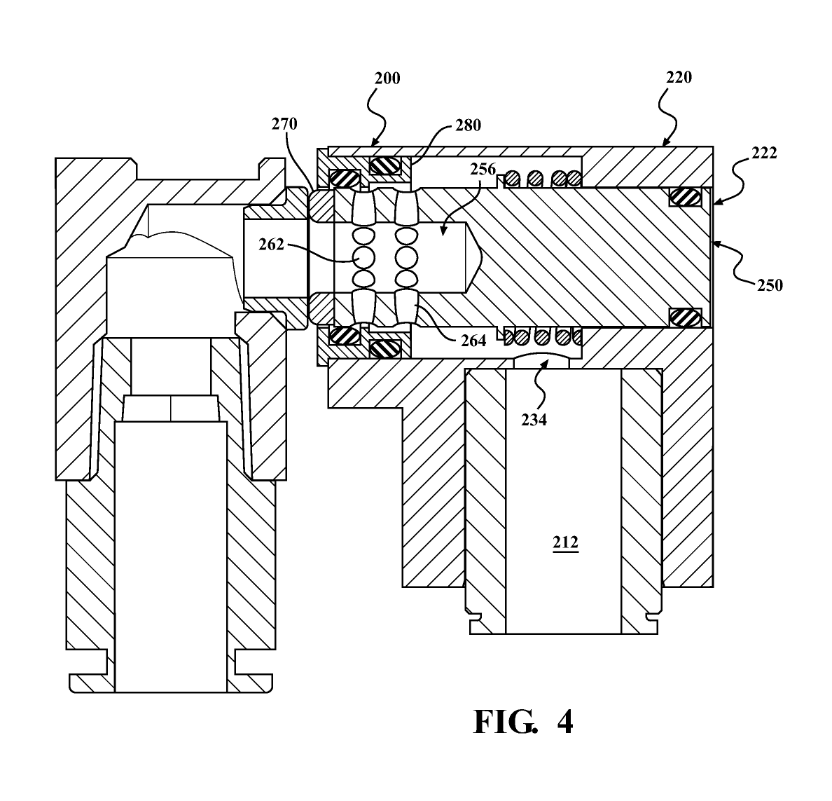

In FIG. 4, the valve member 250 has moved further into the valve bore 222 by engagement of the connecting part 134. The first group of one or more ports 262 and the second group of one or more ports 264 are positioned inward from the valve seat defined by the annular sealing ring 288 such that the internal passageway 256 of the valve member 250 is in communication with valve bore 222 of the valve body 220 via the first group of one or more ports 262 and the second group of one or more ports 264. Thus, the pressurized air passes through the valve member 250 to the second pneumatic coupler portion 130 without leaking.

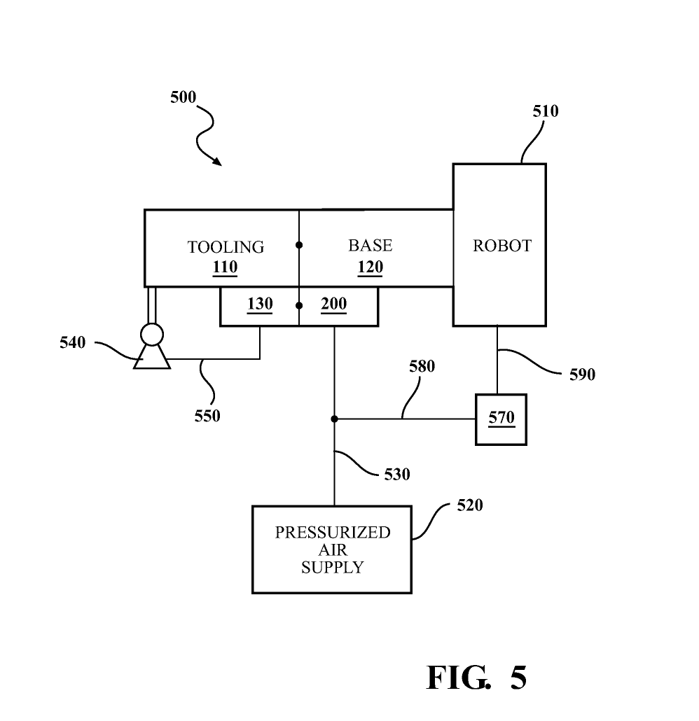

FIG. 5 shows a system 500 that incorporates the first pneumatic coupler portion 200. The system 500 is configured to detect whether the modular tool 110 is properly connected to the base structure 120, and can prevent operation of a prime mover such as a robot 510 when the modular tool 110 is not properly connected to the base structure 120.

The modular tool 110 and the second pneumatic coupler portion 130 are connected to the base structure 120 and the first pneumatic coupler portion 200, respectively. The first pneumatic coupler portion 200 receives pressurized air from a pressurized air supply 520 via a first air line 530. The pressurized air travels onward to a pneumatic tool 540, such as a vacuum gripper, via the first pneumatic coupler portion 200, the second pneumatic coupler portion 130, and a second air line 550.

A sensor 560 is operable to detect the pressure and/or flow rate of the pressurized air that is supplied to the first pneumatic coupler portion 200 in order to sense a leak to atmosphere. For example, the sensor 560 can be positioned along and in communication with the first air line 530. An output signal from the sensor 560 is provided to a controller 570 via a first electrical connection 580. The controller 570 is operable to determine the presence of an air leak based on the output signal, for example, by comparing the output signal to a threshold. If an air leak is detected, the controller 570 can generate one or more command signals. One example of an control signal that can be output by the controller 570 is an alarm signal that is used to indicate incomplete connection of the modular tool 110 with respect to the base structure 120. Another example of a control signal that can be output by the controller 570 is an interlock signal that is provided from the controller 570 to a machine to prevent operation of the machine. As an example the interlock signal can provided to the robot 510 from the controller 570 via a second electrical connected 590 to prevent operation (e.g. movement) of the robot 510. If no air leak is detected and all other requisite conditions for operation of the robot 510 are satisfied, the command signal output by the controller 570 (or the absence of the interlock signal) allows operation of the robot 510.

As a result of the structure of the pneumatic valve of the first pneumatic coupler portion 200, pressurized air will be exposed to atmosphere if the first pneumatic coupler portion 200 is not properly connected to the second pneumatic coupler portion 130, which occurs when the modular tool 110 is not properly connected to the base structure 120. Because the air leak at the first pneumatic coupler portion 200 is detected by the controller 570, operation of the robot 510 is prevented by the controller 570 when the modular tool 110 is not properly connected to the base structure 120. This can prevent damage or injury that might occur as a result of operation of the robot 510 when the modular tool 110 is not fully connected.

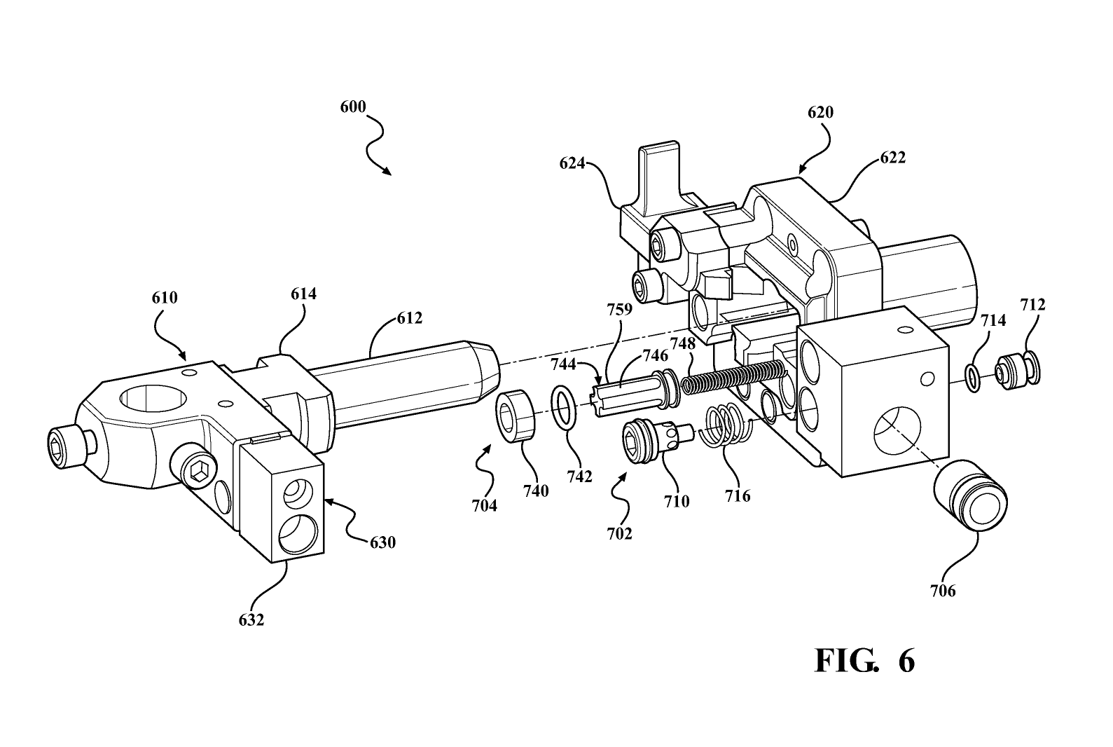

FIG. 6 shows a modular tooling assembly 600 that includes a modular tool 610 and a base structure 620. The modular tool 610 and the base structure 620 are similar to the modular tool 110 and the base structure 120, except as otherwise described herein.

The base structure 620 includes a first mechanical coupler portion 622 and a locking mechanism 624. The locking mechanism 624 can include a moving mechanism such as a pin or a latch that is able to engage and disengage another structure.

The modular tool 610 includes a second mechanical coupler portion 612 and one or more locking features. In the illustrated embodiment, the one or more locking features are flanges 614, but it should be understood that any geometric feature can be used as the locking features so long as they are configured to be engaged and retained by the locking mechanism 624 of the base structure 620. Examples of other suitable locking features includes projections, protrusions, rims, depressions, channels, and holes.

The first mechanical coupler portion 622 of the base structure 620 and the second mechanical coupler portion 612 of the modular tool 610 are connectable and disconnectable to allow the modular tool 610 to be secured to and removed from the base structure 620 by movement of the modular tool 610 between a disconnected position and a connected position with respect to the base structure 620.

The base structure 620 includes a first pneumatic coupler portion 700 that includes a pneumatic supply valve 702, a pneumatic detection valve 704, an inlet 706 and a valve body 708. The inlet 706 of the first pneumatic coupler portion 700 allows pressurized air to enter the first pneumatic coupler portion 700, and is connectable to a source of pressurized air, such as by pneumatic tubing (not shown) or other suitable structures, and provides pressurized air to the pneumatic supply valve 702 and the pneumatic detection valve 704 via one or more internal passages (not shown) that are defined in the valve body 708. The inlet 706 is connected to the valve body 708. In the illustrated implementation the inlet 706 is formed separately from the valve body 708 and subsequently connected to the valve body 708 by conventional structures and methods. In another implementation the inlet 706 is formed integrally with the valve body 708.

The pneumatic supply valve 702 includes a first valve portion 710, a second valve portion 712, a sealing element such as a sealing ring 714 and a biasing element such as a compression spring 716. The pneumatic detection valve 704 includes a bearing ring 740, a sealing element such as a sealing ring 742, a contact shaft 744 that has one or more axially extending depressions 746 formed in it, and a biasing element such as a compression spring 748.

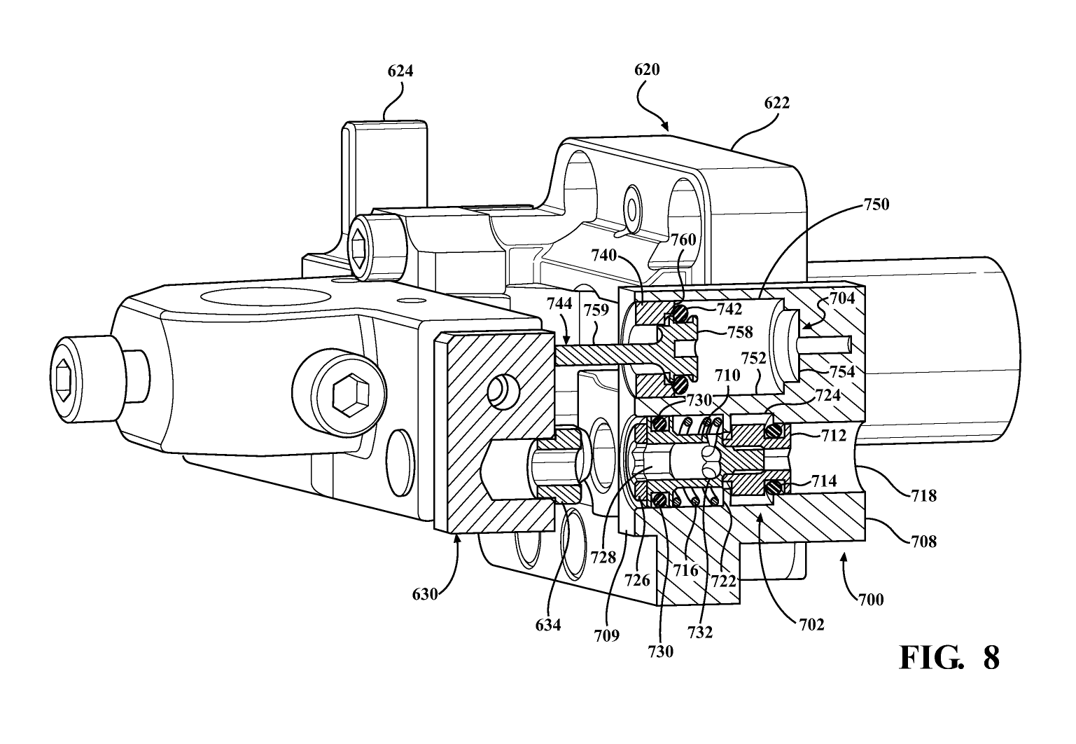

The modular tool 610 includes a second pneumatic coupler portion 630 that has an outlet 632 and a connecting part 634 (FIG. 8). The outlet 632 is connected to one or more pneumatic tools (not shown) that are supported by the modular tool 610, such as by pneumatic tubing (not shown) or other suitable structures.

The first pneumatic coupler portion 700 and the second pneumatic coupler portion 630 can be connected by moving the second pneumatic coupler portion 630 toward the first pneumatic coupler portion 700 and can be disconnected by moving the second pneumatic coupler portion 130 away from the first pneumatic coupler portion 700. The first pneumatic coupler portion 700 and the second pneumatic coupler portion 630 are connected to the modular tool 610 and the base structure 620 such that the motion that occurs during connection and disconnection of the first mechanical coupler portion 622 of the base structure 620 and the second mechanical coupler portion 612 of the modular tool 610 also causes connection and disconnection of the first pneumatic coupler portion 700 and the second pneumatic coupler portion 630.

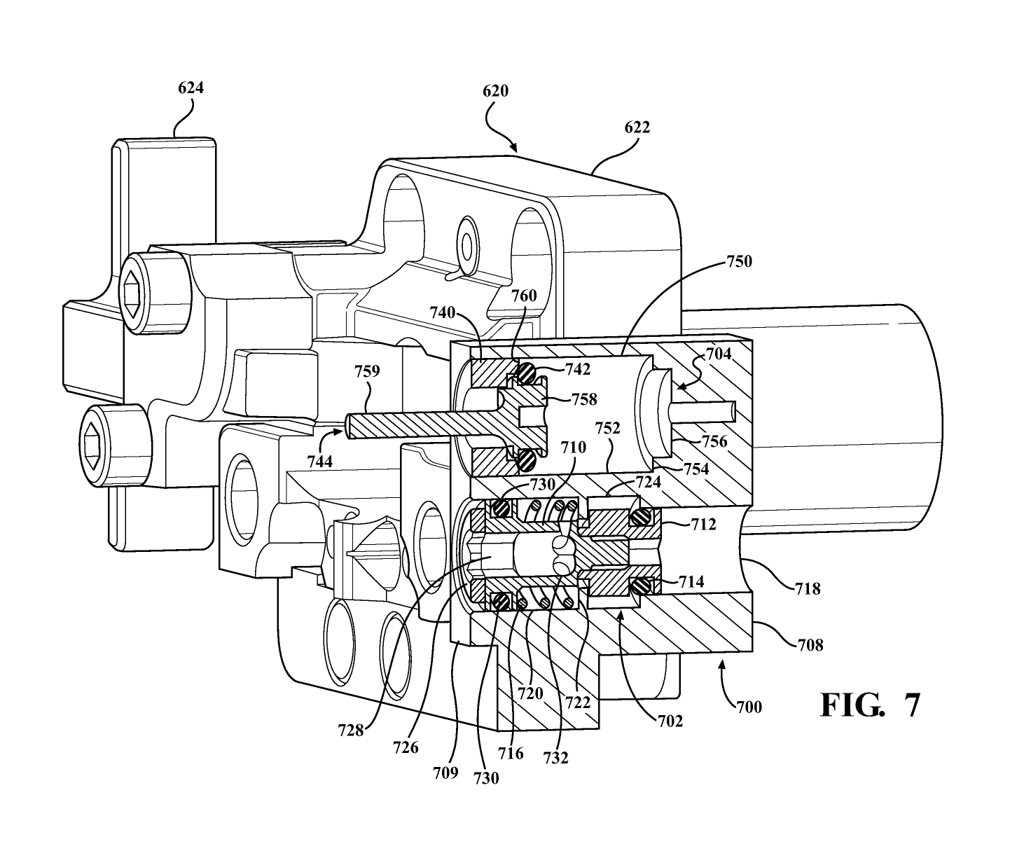

As shown in FIGS. 7-9, the pneumatic supply valve 702 and the pneumatic detection valve 704 are disposed within respective spaces that are defined within the valve body 708 of the first pneumatic coupler portion 700. In particular, the pneumatic supply valve 702 is disposed in a first valve bore 718 and the pneumatic detection valve 704 is disposed within a second valve bore 750 of the valve body 708. The first valve bore 718 and the second valve bore 750 each extend through the valve body 708 along a respective axis. In the illustrated example, the respective axes along which the first valve bore 718 and the second valve bore 750 extend are parallel to each other. The first valve bore 718 and the second valve bore 750 are each in fluid communication with the inlet 706.

The first valve bore 718 extends through the valve body 708 and in the illustrated implementation has two open ends. A first portion 720 of the first valve bore 718 extends from a front surface 709 of the valve body 708, has an annular flange 722 defined within it, and terminates at a second portion 724 of smaller diameter than the first portion 720. The first valve bore 718, in this example, is in fluid communication with the inlet 706 in the area of the first portion 720 between the annular flange 722 and the second portion 724.

The pneumatic supply valve 702 is disposed at least partially within the first valve bore 718 of the valve body 708 and moves along the axis of the first valve bore 718 to block or permit flow of the pressurized air. At a front end of the pneumatic supply valve 702, an annular seal 726 is defined on the first valve portion 710 and surrounds an open end of an internal passageway 728. When the first pneumatic coupler portion 700 is connected to the second pneumatic coupler portion 630, the annular seal 726 allows for sealed engagement with the connecting part 634 so that pressurized air may flow between the internal passageway 728 of the pneumatic supply valve 702 and the connecting part 634 without leaking A sealing element such as a sealing ring 730 extends around the first valve portion 710 of the pneumatic supply valve 702 for sealed engagement with the first portion 720 of the first valve bore 718. One or more ports 732 extend radially through the first valve portion 710 to allow fluid communication between the internal passageway 728 and the first portion 720 of the first valve bore 718.

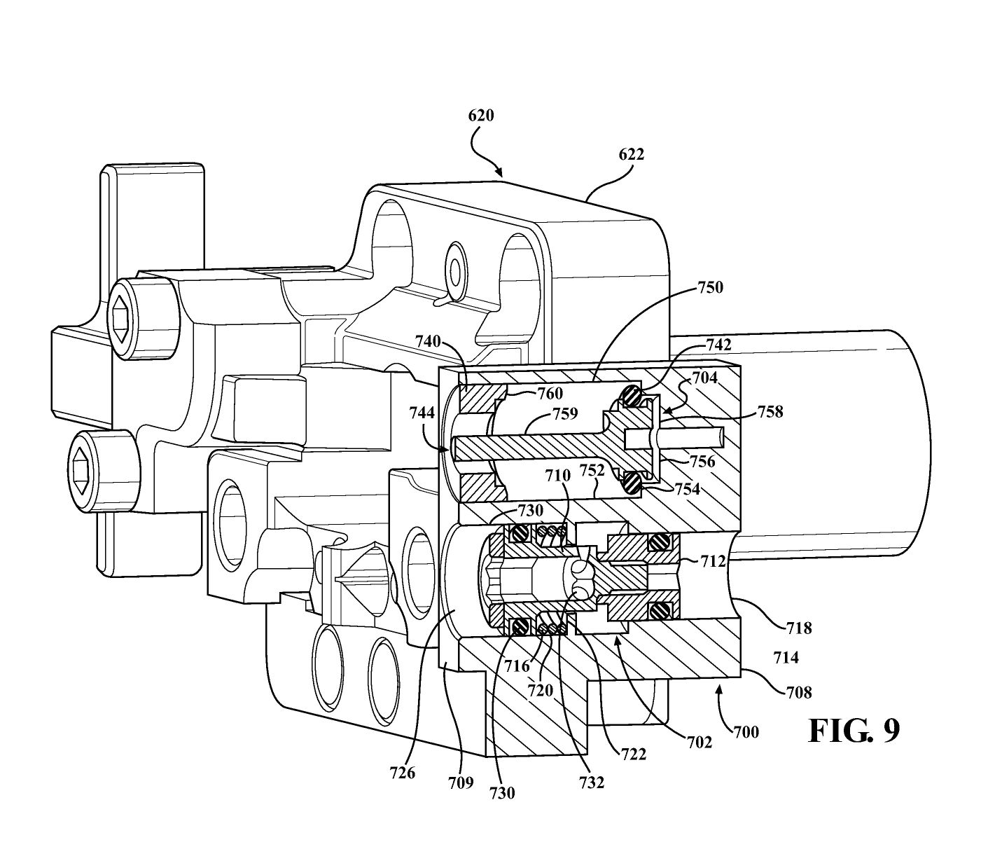

The compression spring 716 engages the first valve portion 710 of the pneumatic supply valve 702 and the annular flange 722 to bias the pneumatic supply valve 702 toward the closed position (FIGS. 7-8) and resist movement toward the open position (FIG. 9). When the pneumatic supply valve 702 is in the closed position, the annular seal 726 is disposed near the front surface 709 of the valve body 708. When the pneumatic supply valve 702 is in the open position, the annular seal 726 is recessed within the first valve bore 718.

The second valve portion 712 is disposed in the first valve bore 718 rearward of the annular flange 722 and limits movement of the pneumatic supply valve 702 in response to the force exerted on it by the compression spring 716 by engagement of the second valve portion 712 with the annular flange 722. In the illustrated example, the diameter of the second valve portion 712 is larger than the diameter of the space surrounded by the annular flange 722. The diameter of the second valve portion 712 can be complementary to the diameter of the second portion 724 of the first valve bore 718 such that the second valve portion 712 fits closely inside the second portion 724 and the sealing ring 714 defines a seal with respect to the second portion 724 to prevent leakage of the pressurized air to atmosphere.

When the pneumatic supply valve 702 is in the closed position (FIGS. 7-8), the internal passageway 728 is not in communication with the pressurized air such that the pressurized air is not supplied by and does not leak from the pneumatic supply valve 702. In response to engagement by the connecting part 634, the compression spring 716 is compressed and the pneumatic supply valve 702 moves rearward along the first valve bore 718. When the one or more ports 732 are disposed rearward of the annular flange 722, the internal passageway 728 in fluid communication with the pressurized air via the one or more ports 732 to establish the open position of the pneumatic supply valve 702 (FIG. 9).

The second valve bore 750 has an outer portion 752 that extends from an open end at the front surface 709 of the valve body 708 to an internal shoulder 754. An inner portion 756 of the second valve bore extends from the internal shoulder 754 and terminates as a closed end of the second valve bore 750. The inner portion 756 of the second valve bore 750 is in fluid communication with the inlet (706).

The contact shaft 744 is disposed at least partially within the second valve bore 750 and is able to slide along the axis of the second valve bore 750 in response to the biasing force exerted upon it by the compression spring 748 and in response to external forces that oppose the force exerted upon the contact shaft 744 by the compression spring 748 as will be explained. The contact shaft has a head portion 758 and a shaft portion 759. The head portion 758 has a larger diameter than the remainder of the contact shaft 744, including the shaft portion. The axially extending depressions 746 are formed on the shaft portion 759, and the shaft portion 759 is sized and configured to be supported within and slide axially with respect to the bearing ring 740.

The sealing ring 742 is disposed on the head portion 758 such that the center of the sealing ring is aligned with the axis of the second valve bore 750. Features can be formed on the head portion 758 to prevent the sealing ring 742 from moving axially with respect to the head portion 758, such as a shallow annular channel or annular projections that extend outward from the head portion 758.

The contact shaft 744 is retained partially within the second valve bore 750 by the bearing ring 740. The bearing ring 740 is disposed at least partially within the second valve bore 750 at the front surface 709 of the valve body 708, and can be connected to the valve body by any suitable method or structure, such as by a threaded connection. The bearing ring 740 has an internal diameter similar to the external diameter of the portion of the contact shaft 744 that extends through the bearing ring 740 such that the contact shaft 744 is able to slide axially relative to the bearing ring 740 without excessive lateral movement. Because of the axially extending depressions 746, however, fluid flow through the bearing ring 740 is permitted.

The contact shaft 744 moves axially along the second valve bore 750 between a fully extended position (FIG. 7) and a fully retracted position (FIG. 9). In the fully extended position, head portion 758 of the contact shaft 744 is seated against the bearing ring 740 with the sealing ring 742 engaged with a surface 760 of the bearing ring 740 to define a seal that prevents leaking of the pressurized air from the second valve bore 750 to atmosphere. While the head portion 758 is engaged with the bearing ring 740, the contact shaft 744 extends out of the second valve bore 750 by a distance that is similar to the distance between the bearing ring 740 and the internal shoulder 754 of the second valve bore 750. In the fully retracted position of the contact shaft 744, the sealing ring 742 engages the internal shoulder 754 to seal the inner portion 756 of the second valve bore 750 from the outer portion 752 of the second valve bore 750. In the fully retracted position of the contact shaft 744, the contact shaft 744 is disposed entirely within the second valve bore 750, the contact shaft 744 does not extend out of the second valve bore 750 past the front surface 709 of the valve body 708, and the contact shaft 744 is disposed entirely within the second valve bore 750.

The pneumatic detection valve 704 is configured to allow the pressurized air to atmosphere while the contact shaft 744 is disposed in an intermediate position (FIG. 8) between the fully extended position and the fully retracted position. In particular, the outer portion 752 of the second valve bore 750 is configured such that the head portion 758 and the sealing ring 742 do not define a complete seal with respect to the second valve bore 750. In the illustrated example, the inside diameter of the outer portion 752 of the second valve bore 750 is greater than the outside diameter of the sealing ring 742. Thus, fluid such as the pressurized air from the inlet 406 may pass the head portion 758 of the contact shaft 744 while it is disposed between the fully extended position and the fully retracted position.

In operation, when the first mechanical coupler portion 622 of the base structure 620 and the second mechanical coupler portion 612 of the modular tool 610 are disconnected, the pneumatic supply valve 702 is in the closed position and the pneumatic detection valve 704 is in the fully extended position, as shown in FIG. 7. To connect the first mechanical coupler portion 622 of the base structure 620 and the second mechanical coupler portion 612, the coupler portions are brought into engagement and moved toward each other. As the modular tool 610 approaches the base structure 620, the second pneumatic coupler portion 630 likewise approaches the first pneumatic coupler portion 700 and the second pneumatic coupler portion 630 engages the contact shaft 744. Engagement of the second pneumatic coupler portion 630 with the contact shaft 744 moves the contact shaft 744 to the partially engaged position against the force exerted by the compression spring 748, thereby allowing the pressurized air to communicate with atmosphere through the pneumatic detection valve 704. In the illustrated example, the contact shaft 744 engages the second pneumatic coupler portion 630 before the connecting part 634 of the second pneumatic coupler portion engages the pneumatic supply valve 702. The modular tool 610 continues moving toward the base structure 620 until the pneumatic supply valve 702 reaches the open position to allow supply of the pressurized air to the second pneumatic coupler portion 630, the pneumatic detection valve 704 reaches the fully retracted position thereby blocking flow of the pressurized air to atmosphere, and the locking mechanism 624 engages with respect to the flanges 614 of the modular tool 610 to secure the modular tool 610 with respect to the base structure 620.

The modular tooling assembly 600 can be utilized in the system 500 in place of the previously described components of the modular tooling assembly 100. Thus, while the pneumatic detection valve 704 is in the intermediate position, the change in pressure and/or flow rate can be recognized by the sensor 560 and the resulting signal can be utilized by the controller 570 in the same manner as previously described.

Although some of the examples given above refer to compressed air (i.e. air at greater than atmospheric pressure), it should be understood that the teachings herein are generally applicable to supply of gas at any pressure. Thus, examples that reference “air” are equally applicable to any type of gas, and examples that are made with reference to a compressed gas are also applicable to use with gas at negative (e.g. vacuum) pressure.

While the description is made in connection with certain embodiments, it is to be understood that the disclosure is directed to various modifications and equivalent arrangements included within the scope of the claims, which are to be accorded the broadest reasonable interpretation as is permitted under the law so as to encompass such modifications and equivalent arrangement.

1. An apparatus, comprising:
a mechanical coupler portion; and
a pneumatic detection valve that is connected to the mechanical coupler portion, is connectable to a source of pressurized air, and is moveable between a first position and a second position, wherein the pneumatic detection valve prevents communication of the pressurized air with atmosphere in the first position, prevents communication of the pressurized air with atmosphere in the second position, and leaks the pressurized air to atmosphere when in an intermediate position between the first position and the second position.

2. The apparatus of claim 1, further comprising:
a sensor that is operable to sense at least one of a pressure or a flow rate of the pressurized air.

3. The apparatus of claim 2, further comprising:
a controller that receives an output signal from the sensor and detects a leak to atmosphere by the pneumatic detection valve based on the output signal.

4. The apparatus of claim 3, wherein the controller outputs an interlock signal for preventing operation of a machine in response to detecting the leak to atmosphere.

5. The apparatus of claim 1, further comprising:
a pneumatic supply valve that is operable to supply the pressurized air to a modular tool.

6. The apparatus of claim 5, wherein the pneumatic supply valve is moveable between an open position and a closed position.

7. The apparatus of claim 6, wherein the pneumatic supply valve is disposed in the closed position when the pneumatic detection valve is disposed in the first position and the pneumatic supply valve is disposed in the open position when the pneumatic detection valve is disposed in the second position.

8. The apparatus of claim 1, wherein the pneumatic detection valve includes a contact shaft that is disposed at least partially within a valve bore that is formed in a valve body.

9. The apparatus of claim 8, wherein a portion of the contact shaft extends out of an open end of the valve bore when the pneumatic detection valve is in the first position.

10. The apparatus of claim 9, wherein the contact shaft is disposed entirely within the valve bore when the pneumatic detection valve is in the second position.

11. An apparatus, comprising:
a base structure having:
a first mechanical coupler portion, and
a first pneumatic coupler portion that is connected to the first mechanical coupler portion, is connectable to a source of pressurized air, includes a pneumatic detection valve that is moveable between a first position and a second position, wherein the pneumatic detection valve prevents communication of the pressurized air with atmosphere in the first position, prevents communication of the pressurized air with atmosphere in the second position, and leaks the pressurized air to atmosphere when in an intermediate position between the first position and the second position, and includes a pneumatic supply valve that is moveable between an open position and a closed position; and
a modular tool having:
a second mechanical coupler that is moveable with respect to the first mechanical coupler portion between a disconnected position and a connected position, and
a second pneumatic coupler portion that is connectable to the first pneumatic coupler portion, the second pneumatic coupler portion having a connecting part that is operable to receive the pressurized air from the pneumatic supply valve.

12. The apparatus of claim 11, wherein engagement of at least a portion of the modular tool with the pneumatic detection valve is operable to move the pneumatic detection valve between the first position and the second position.

13. The apparatus of claim 11, further comprising:
a sensor that is operable to sense at least one of a pressure or a flow rate of the pressurized air.

14. The apparatus of claim 13, further comprising:
a controller that receives an output signal from the sensor and detects a leak to atmosphere by the pneumatic detection valve based on the output signal.

15. The apparatus of claim 14, wherein the controller outputs an interlock signal for preventing operation of a machine in response to detecting the leak to atmosphere.

16. The apparatus of claim 11, wherein the pneumatic supply valve is disposed in the closed position when the pneumatic detection valve is disposed in the first position and the pneumatic supply valve is disposed in the open position when the pneumatic detection valve is disposed in the second position.

17. The apparatus of claim 11, wherein the pneumatic detection valve includes a contact shaft that is disposed at least partially within a valve bore that is formed in a valve body of the first pneumatic coupler portion.

18. The apparatus of claim 17, wherein a portion of the contact shaft extends out of an open end of the valve bore when the pneumatic detection valve is in the first position.

19. The apparatus of claim 18, wherein the contact shaft is disposed entirely within the valve bore when the pneumatic detection valve is in the second position.

20. An apparatus, comprising:
a base structure having:
a first mechanical coupler portion, and
a first pneumatic coupler portion that is connected to the first mechanical coupler portion, is connectable to a source of pressurized air, the first pneumatic coupler portion includes a pneumatic detection valve that is moveable between a first position and a second position, wherein the pneumatic detection valve prevents communication of the pressurized air with atmosphere in the first position, prevents communication of the pressurized air with atmosphere in the second position, and leaks the pressurized air to atmosphere when in an intermediate position between the first position and the second position, the pneumatic detection valve includes a contact shaft that is disposed at least partially within a valve bore that is formed in a valve body of the first pneumatic coupler portion, a portion of the contact shaft extends out of an open end of the valve bore when the pneumatic detection valve is in the first position, the contact shaft is disposed entirely within the valve bore when the pneumatic detection valve is in the second position, and the first pneumatic coupler portion includes a pneumatic supply valve that is moveable between an open position and a closed position, wherein the pneumatic supply valve is disposed in the closed position when the pneumatic detection valve is disposed in the first position and the pneumatic supply valve is disposed in the open position when the pneumatic detection valve is disposed in the second position;
a modular tool having:
a second mechanical coupler that is moveable with respect to the first mechanical coupler portion between a disconnected position and a connected position, and
a second pneumatic coupler portion that is connectable to the first pneumatic coupler portion, the second pneumatic coupler portion having a connecting part that is operable to receive the pressurized air from the pneumatic supply valve, wherein engagement of at least a portion of the modular tool with the pneumatic detection valve is operable to move the pneumatic detection valve between the first position and the second position, and
a sensor that is operable to sense at least one of the pressure or the flow rate of the pressurized air; and
a controller that receives an output signal from the sensor and detects a leak to atmosphere by the pneumatic detection valve based on the output signal, wherein the controller outputs an interlock signal for preventing operation of a machine in response to detecting the leak to atmosphere.
